(19) United States
(12) Patent Application Publication
(10) Pub. No.: US 2002/0100625 A1
(43) Pub. Date: Aug. 1, 2002

(54) Drive assembly

(76) Inventors: Carlo Leo Beltrame, East Ivanhoe (AU); Arthur J. Barnes, North Altona (AU)

Correspondence Address: MILES & STOCKBRIDGE P.C., Suite 500, 1751 Pinnacle Drive, McLean, VA, 22102, US

(21) Appl. No.: 10/060,283

(22) Filed: Feb. 1, 2002

(30) Foreign Application Priority Data
Feb. 1, 2001 (AU) PR 2824

(51) Int. Cl. B60K 1/00

(52) U.S. Cl. 180/65.5; 180/206

(57) ABSTRACT

A drive assembly is provided which is especially suitable for use on a golf buggy or other vehicle adapted to be pushed or pulled by an operator in either a forward or a reverse direction. The drive assembly includes a wheel mounted for rotation about an axle, an electromagnetic drive assembly adapted to rotate the wheel about the axle, and a controller responsive to the operator initially moving the vehicle either in a forward or reverse direction to actuate the electromagnetic drive assembly to continue to drive the wheel in the selected direction.

### BACKGROUND OF THE INVENTION

1. Field of the Invention

The present invention relates to a drive assembly for a vehicle, such as a golf buggy or cart, trolley, or parcel carrier, which is adapted to be pushed or pulled by an operator in either a forward or a reverse direction.

The present invention relates particularly to a drive assembly for a golf buggy and the following description is in relation to this application.

It is emphasised that the present invention is not restricted to this application.

2. Description of Related Art

A conventional golf buggy comprises a support frame for a golf bag mounted on a pair of wheels. In use, a golfer either pushes or pulls the golf buggy. For many golfers the necessity to push or pull the conventional golf buggy is particularly tiresome and detracts from the pleasure of playing golf and, in some instances, particularly in the case of older golfers, limits the extent to which the golfers can play golf.

It is known to motorise golf buggies by mounting a motor to the support frame and coupling the motor through a transmission system, such as gears, chains or shafts, to the wheels. However, such motorised golf buggies are noisy, cumbersome, and often difficult to use.

In International application PCT/AU91/00137 (WO 91/16755) the applicants proposed an improvement to the conventional motorised golf buggy described in the preceding paragraph. The improved device includes a golf buggy wheel having an internal chamber and an electromagnetic drive assembly located in the chamber that is operable to drive the wheel and thereby drive the golf buggy.

An object of the present invention is to provide a drive assembly for a golf buggy (and for other applications) which incorporates improvements over the arrangement disclosed in International application PCT/AU91/00137.

### SUMMARY OF THE INVENTION

According to the present invention there is provided a drive assembly for at least partially driving a vehicle, such as a golf buggy or cart, a trolley, or a parcel carrier, which is adapted to be pushed or pulled by an operator in a forward direction or a reverse direction, the drive assembly including:

i. a wheel adapted to be mounted for rotation about an axle;

ii. an electromagnetic drive assembly adapted to rotate the wheel about the axis; and

iii. a means responsive to the operator initially moving the vehicle in the forward direction or the reverse direction to actuate the electromagnetic drive assembly to continue movement of the wheel in the selected direction.

The drive actuation means enables the drive assembly to respond directly to an initial movement by an operator of the vehicle in a selected direction. Therefore, in the case of a golf buggy, if a golfer commences to push or pull the golf buggy in a forward direction or a reverse direction, the drive actuation means will respond directly to the initial golfer-actuated movement to actuate the electromagnetic drive assembly to continue to move the golf buggy in the selected direction.

The drive actuation means may be any suitable means.

It is preferred that the drive actuation means includes:

i. a means for sensing the direction of movement of the wheel; and

ii. a control means responsive to the sensing means for actuating a switch or other means to actuate the electromagnetic drive assembly to continue to drive the wheel in the initial direction of movement selected by the operator.

It is preferred that the control means includes a timed standby mode state which is activated by an operator-initiated input signal for allowing the operator a predetermined time period, typically 5 seconds, for moving the vehicle in the forward or reverse directions, whereby the standby mode state deactivates if the vehicle is not moved within the time period and a further input signal is required for reactivating the standby mode state in order to actuate the electromagnetic drive assembly.

It is preferred that the wheel includes an internal chamber which houses components of the electromagnetic drive assembly.

It is preferred that the electromagnetic drive assembly includes a plurality of magnets located in the chamber and supported to rotate with the wheel.

The magnets may be in any suitable arrangement. For example, the magnets may be spaced apart.

Alternatively, the magnets may be end to end.

The magnets may be of any suitable type. For example the magnets may be button magnets.

It is preferred that the magnets be arranged so that one end of each magnet faces the chamber and the ends of adjacent magnets are of opposite polarity.

It is preferred that the electromagnetic drive assembly further includes a single phase or a multi-phase stator located in the chamber and supported to be stationary with respect to the axle.

It is preferred particularly that the stator be a 3-phase stator.

It is preferred that the stator includes a plurality of poles extending radially from an axis of rotation of the wheel and one or more coils wound around the poles, with the number of coils equaling the number of phases.

In the case of a multi-phase stator, it is preferred that the poles be divided into a number of groups that equals the number of phases, and the poles in each group be wound with a separate coil.

In particular, in the case of a three-phase stator it is preferred that every third pole be wound by one of three separate coils.

It is preferred particularly that each coil be wound oppositely on successive poles.

It is preferred that the electromagnetic drive assembly further includes a dc power source.

It is preferred that the dc power source be connected to each coil.

It is preferred that the chamber houses the dc power source.

It is preferred particularly that the dc power source be a battery.

According to the present invention there is provided a vehicle which includes the drive assembly described in the preceding paragraphs.

It is preferred that the vehicle be a golf buggy.

The present invention is described hereinafter in more detail with reference to the accompanying drawings in which:

### BRIEF DESCRIPTION OF THE DRAWINGS

FIG. 1 is a partially schematic cross-section of a preferred embodiment of a drive assembly in accordance with the present invention; and

FIG. 2 is a partial cross-section along the line 2-2 of FIG. 1.

### DETAILED DESCRIPTION OF THE PREFERRED EMBODIMENTS

The preferred embodiment of the drive assembly is particularly adapted for use in connection with golf buggies and will be described in this context. However, it is emphasised that the present invention is not limited to this application and also extends to other vehicles, such as trolleys and parcel carriers, which are adapted to be pushed or pulled by an operator in a forward direction or a reverse direction.

The main components of the drive assembly shown in the figures are:

i. a golf buggy wheel 3 which is generally conventional in terms of external appearance;

ii. an electromagnetic drive assembly which is operable in use to at least partially drive the wheel 3 in either a forward direction or a reverse direction; and

iii. a means to actuate the electromagnetic drive assembly in response to a golfer initially moving a golf buggy to which the wheel 3 is attached in a selected forward direction or a reverse direction.

The wheel 3 includes a stationary axle 5. The wheel 3 further includes a ground-engaging tread 9 and inner and outer side walls 7 which form an integral assembly that is supported by bearings 11 for rotation about the axle 5. The axle 5 is adapted to be detachably mounted to a conventional golf buggy (not shown).

The wheel 3 further includes an internal chamber 13 which houses the main components of the electromagnetic drive assembly and the drive actuation means, as is described hereinafter.

The electromagnetic drive assembly includes a plurality of equi-spaced magnets 15 located in the chamber 13. The magnets 15 are positioned in a locating ring 31 which, in turn, is connected to an internal wall of the tread 9. As a consequence, the magnets 15 are supported to rotate with the wheel 3.

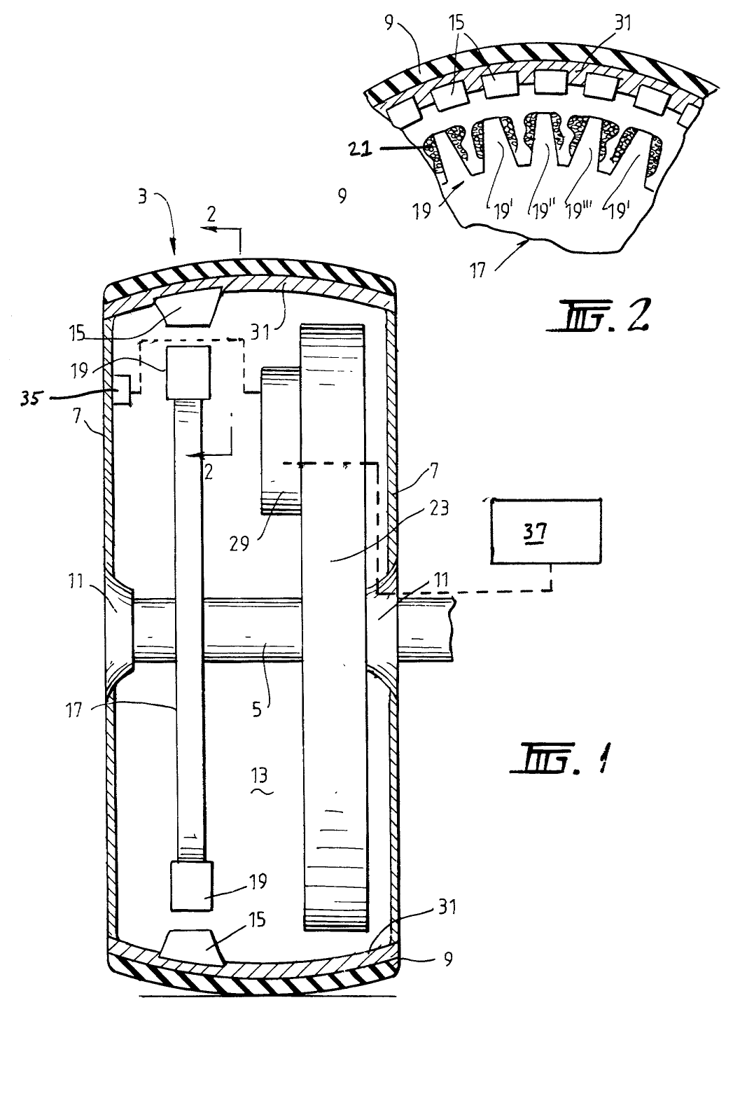

The electromagnetic drive assembly further includes a stator 17 located in the chamber 13. The stator 17 is fixed to the axle 5 and includes a plurality of radially extending poles identified by the numeral 19 in FIG. 1 and by the numerals 19′, 19″ and 19′″ in FIG. 2. The stator 17 may be a single or multi-phase stator. The stator 17 further includes one or more coils 21 wound onto the poles 19—depending on whether the stator 17 is a single or multi-phase stator. By way of example, in the case of a three-phase stator, it is preferred that the stator includes:

i. a first coil, which forms phase a of the three-phase stator 17, wound around a pole 19′ and then wound successively around every third pole;

ii. a second coil, which forms phase b of the three-phase stator 17, wound around a pole 19″ which is adjacent the pole 19′ and then wound successively around every third pole; and

iii. a third coil, which forms phase c of the three-phase stator 17, wound around a pole 19′″ which is adjacent pole 19″ and then wound successively around every third pole.

It is preferred that the successive pole 19 of each of the three groups of poles be wound oppositely.

The number of magnets 15 and poles 19 are selected so that four magnets 15 oppose three poles 19.

The electromagnetic drive assembly further includes an integrated power supply in the form of a battery pack 23 preferably located in the chamber 13 and electrically connected to the coils 21 of the stator 17.

The drive actuation means includes a sensor shown schematically at 35 for detecting the direction of movement of the wheel 3 in an initial direction selected by a golfer. The sensor may be any suitable type of sensor. One such sensor type includes sensors based on sensing back EMF generated when the golfer moves the golf buggy in a forward or a reverse direction. The drive actuation means also includes a control means 29 which has a programmable memory. The control means 29 is adapted to respond to the sensor and actuate a switch (not shown) which actuates the electromagnetic drive assembly by allowing current from the battery pack 23 to energise the stator coils 21, whereby the electromagnetic drive assembly continues to drive the wheel 3 in the initial direction of movement of the wheel 3 selected by the golfer.

In accordance with one embodiment, the control means 29 operates as follows:

i. the sensor detects movement of a first pole relative to a position;

ii. the sensor detects movement of a second pole past the position;

iii. the sensor determines direction of movement from the sensed information of i and ii; and

iv. the programmable memory responds to the sensor and activates a chemical switch or other means which actuates the electromagnetic drive assembly by allowing current from the battery pack 23 to energise the coils 21, whereby the electromagnetic drive assembly continues movement of the wheel in the selected direction of movement.

It can readily be appreciated that in use, the above-described preferred embodiment is directly responsive to a golfer moving the golf buggy in a selected direction to provide drive to continue to move the golf buggy in the selected direction.

The control means 29 includes a timed standby mode state which is activated by an operator-initiated input signal from an operator input device, shown schematically at 37. This is included as a safety feature. In the standby mode state, a golfer has a predetermined time period, typically five seconds, within which to push the golf buggy forward or to pull the buggy backward. If a golfer pushes/pulls the golf buggy within the time period, the drive actuation means operates as described above and the electromagnetic drive assembly continues to drive the wheel in the direction selected by the golfer. If the golfer does not push/pull the golf buggy within the time period, the standby mode state automatically deactivates and the golfer must generate a further input signal to reactivate the standby mode state to thereafter drive the wheel.

Many modifications may be made to the preferred embodiment described above without departing from the spirit and scope of the present invention.

For example, whilst the electromagnetic drive assembly of the preferred embodiment comprises a three-phase motor, it can readily be appreciated that the present invention is not limited to such an arrangement and extends to any suitable electromagnetic drive assembly.

1. A drive assembly for at least partially driving a vehicle, such as a golf buggy or cart, a trolley, or a parcel carrier, which is adapted to be pushed or pulled by an operator in a forward direction or a reverse direction, the drive assembly including:
i. a wheel adapted to be mounted for rotation about an axle;
ii. an electromagnetic drive assembly adapted to rotate the wheel about the axis; and
iii. a means responsive to the operator initially moving the vehicle in the forward direction or the reverse direction to actuate the electromagnetic drive assembly to continue movement of the wheel in the selected direction.

2. The drive assembly defined in claim 1 wherein the drive actuation means includes:
i. a means for sensing the direction of movement of the wheel; and
ii. a control means responsive to the sensing means for actuating a switch or other means to actuate the electromagnetic drive assembly to continue to drive the wheel in the initial direction of movement selected by the operator.

3. The drive assembly defined in claim 2 wherein the control means includes a timed standby mode state which is activated by an operator-initiated input signal for allowing the operator a predetermined time period in which to move the vehicle in the forward or reverse directions, whereby the standby mode state deactivates if the vehicle is not moved within the time period and a further input signal is required for reactivating the standby mode state in order to actuate the electromagnetic drive assembly.

4. The drive assembly defined in claim 1 wherein the wheel includes an internal chamber which houses components of the electromagnetic drive assembly.

5. The drive assembly defined in claim 4 wherein the electromagnetic drive assembly includes a plurality of magnets located in the chamber and supported to rotate with the wheel.

6. The drive assembly defined in claim 5 wherein the magnets are arranged so that one end of each magnet faces the chamber and the ends of adjacent magnets are of opposite polarity.

7. The drive assembly defined in claim 4 wherein the electromagnetic drive assembly further includes a single phase or a multi-phase stator located in the chamber and supported to be stationary with respect to the axle.

8. The drive assembly defined in claim 7 wherein the stator is a three-phase stator.

9. The drive assembly defined in claim 7 wherein the stator includes a plurality of poles extending radially from an axis of rotation of the wheel and one or more coils wound around the poles, with the number of coils equalling the number of phases.

10. The drive assembly defined in claim 7 wherein the stator is a multi-phase stator, and wherein the poles are divided into a number of groups that equals the number of phases, and the poles in each group are wound with a separate coil from the coil or coils used to wind each other group.

11. The drive assembly defined in claim 10 wherein the stator is a three-phase stator, and wherein every third pole is wound by one of three separate coils.

12. The drive assembly defined in claim 1 wherein the electromagnetic drive assembly further includes a DC power source.

13. The drive assembly defined in claim 3 wherein the electromagnetic drive assembly includes a dc power source located in the chamber.

14. A golf buggy that incorporates the drive assembly defined in claim 1.
